(19) United States
(12) Patent Application Publication
(10) Pub. No.: US 2006/0149639 A1
(43) Pub. Date: Jul. 6, 2006

(54) Method and system for creating a purchase suggesting list retailers

(75) Inventors: Xiao-Ling Liu, Taipei (TW); Chia-Chun Lee, Taipie (TW); Jeff Song, Taipei (TW); Win-Harn Liu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/096,947

(22) Filed: Mar. 31, 2005

(30) Foreign Application Priority Data
Dec. 31, 2004 (TW) 093141837

(51) Int. Cl. G06Q 30/00

(52) U.S. Cl. 705/26

(57) ABSTRACT

A system for generating a purchase suggestion list is proposed, comprising: a supplier enterprise resource planning (ERP) system that regularly inputs data of past orders from each of its retail customers into the order database, a retailer computer system regularly that inputs the quantity of each inventory into the inventory database, a data input module for manually inputting the safety margin and purchasing time period, a data storage module to read the order and inventory information, a calculating module for calculating the suggested quantity of each product for purchase, which is also manually adjustable by the inventory management staff, to create a purchase suggesting list, and a data transfer module that transfers this purchase suggestion list to the retailer to make final modifications or grant approval so that a final order can be made under the mutual agreement based on the suggestion purchase list. The present invention also proposes a method for generating a purchase suggestion list.

### FIELD OF THE INVENTION

The present invention relates to a method and system for creating purchase suggestion lists, and more particularly, to a method and a system for creating purchase suggestion lists targeted at a supplier's retail customers.

### BACKGROUND OF THE INVENTION

Retailers often manually place an order for items when inventory is low in stock. This process of manually ordering not only wastes human resources in spent time checking the inventory and ordering items, but also results in ordering mistakes due to human error, thus delaying the delivery of new stock and leading to lost revenue due to stock insufficiency. If the ordering process could be automated according to how much inventory was on hand at a given time, then, whenever the inventory number fell below a predetermined number, the system could automatically place an order to the supplier, thus avoiding the expenditure of human resources and eliminating human error. However, this kind of automated system also has a weakness in that, since the ordering is not fixed to a certain time period, there is a possibility that the supplier may not have enough inventory in stock to fill the order in a timely fashion.

After an order is placed by a retailer, a supplier delivers the goods accordingly; however, since it is difficult for the supplier to actually estimate the time and how many products a retailer may order, it is difficult to keep track of the outgoing stock and therefore get a hold on how many products should be manufactured.

### SUMMARY OF THE INVENTION

A primary objective of the present invention is to provide a method and a system for sending a purchase suggestion list to the retailers and this purchase suggestion list can then be modified and approved by each retailer to produce a final purchase list, allowing the supplier to effectively get control of the ordering time and knowledge of the numbers of products that will be ordered.

In order to achieve the foregoing objective, the system for creating a purchase suggestion list for retailers proposed by the present invention is established through a connection from a supplier enterprise resource planning (ERP) system to at least one retailer computer system through a computer network system such as the Internet for regularly offering each corresponding retailer a purchase suggestion list. Such lists are then modified and approved by each retailer to generate final purchase lists. The system of creating these purchase suggestion lists comprises: a computer network system, such as the Internet or on intranet; supplier enterprise resource planning (ERP) system for handling business activity such as issuing catalogs of goods to retailers, inventory management, and shipping; a retailer system for handling business activity such as purchasing, sales, and inventory management; an ordering database for storing data such as order numbers, retailer numbers, supplier numbers, catalog numbers of goods, quantities of products ordered, warehouse numbers, and so on; a purchasing suggestion list database for storing information such as purchasing suggestion list numbers, retailer numbers, supplier numbers, purchase time periods, safety margins, and suggesting the quantity of product that should be purchased, in which the suggested quantity for purchase is further classified into automatic suggestions generated by the system and manual suggestions input by the inventory staff; an inventory database for storing data such as warehouse numbers and catalog numbers; a data storing module for saving data such as in an order database, a purchasing suggestion database, and an inventory database; a data input module, for the inventory staff to input data related to the ordering time period, safety margins, and the suggested quantity of product to be purchased; a calculating module for calculating the quantity of each suggested product to be purchased for each retailer and automatically generating a purchasing suggestion list; and a data transferring module for transferring the purchasing suggestion list to each retailer as well as transferring the modified purchasing order back to the supplier.

The method for generating purchasing suggestion lists of the invention comprises the following steps: regularly transferring orders from each retailer into an ordering database through an enterprise resource planning (ERP) system; creating a purchasing suggestion list including the quantity of each product that is suggested for each retailer to purchase, calculated from input parameters such as safety margins, purchase time periods, purchasing history and inventory data, or manually input by the inventory staff; saving the purchasing suggestion list for each retailer into the purchasing suggestion database and sending the purchasing suggestion lists to corresponding retailers, which are then either approved or modified by the retailers and transferred back to the supplier enterprise resource planning (ERP) system; whereupon, if the supplier approves the modified purchasing suggestion list, a final purchasing list is generated according to each purchasing suggestion list and saved into the order database, but if the supplier makes some further modifications to the purchasing suggestion list, then the purchasing suggestion list is sent back to the corresponding retailer computer system for a second-round of confirmation until both sides have reached agreement.

In summary, the method and system for creating purchasing suggestion lists comprises: a supplier enterprise resource planning (ERP) system that regularly inputs data of past orders from each of its retail customers into the order database, a retailer computer system regularly that inputs the quantity of each inventory into the inventory database, a data input module for manually inputting the safety margin and purchasing time period, a data storage module to read the order and inventory information, a calculating module for calculating the suggested quantity of each product for purchase, which is also manually adjustable by the inventory management staff, to create a purchase suggesting list, and a data transfer module that transfers this purchase suggestion list to the retailer to make final modifications or grant approval so that a final order can be made under the mutual agreement based on the suggestion purchase list.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram showing the basic assembly of the system for creating a purchasing suggestion list of the present invention; and

FIG. 2 is a schematic flow chart, showing procedural steps of a method of creating a purchasing suggestion list, in accordance with the invention.

### DETAILED DESCRIPTION OF THE PRFERRED EMBODIMENTS

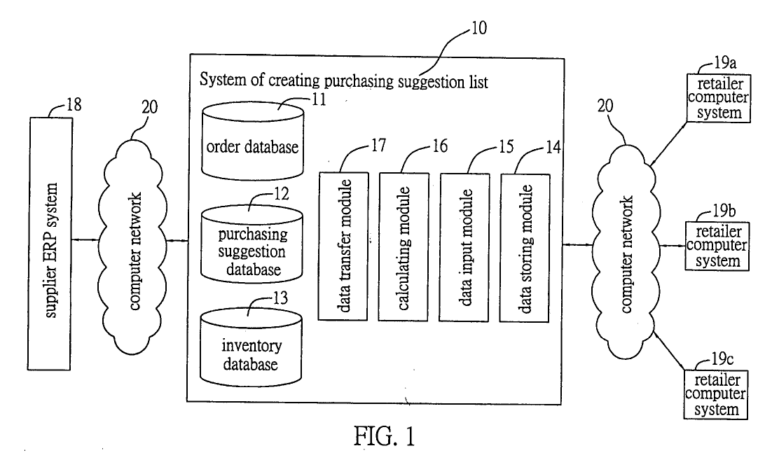

FIG. 1 is a schematic block diagram showing the basic assembly of the system for creating a purchasing suggestion list of the invention. As shown in the drawing, the system of creating a purchasing suggestion list of the invention comprises: order database 11, purchasing suggestion database 12, inventory database 13, data storing module 14, data input module 15, calculating module 16, data transfer module 17, supplier enterprise resource planning (ERP) system 18, retailer computer system 19 (19a, 19b and 19c, in which retailer computer system 19a is used to exemplify the preferred embodiments of the invention) and a computer network 20 such as the Internet or intranet.

Supplier enterprise resource planning (ERP) 18 comprises complete information in regard to the assets of the supplier, manufacturing, finance, and sales of the supplier for handling business activities such as issuing catalogs of goods to the retailers, receiving orders, and sales.

Retailer computer system 19a comprises information about the purchases, finance and sales of the retailer, for handling business activities such as purchasing, sales, customer management, warehouse management, payment management and statistics.

Order database 11 comprises order data such as order number, retailer number, supplier number, catalog number, quantity of purchase, and warehouse number, which are input regularly from the retailer order into the order database through the enterprise resource planning system in order for the system to automatically suggest a purchasing quantity for each supplied product for the retailers, or manually input by the inventory management staff.

Inventory database 13 comprises inventory information such as warehouse number, catalog number, and quantity of the inventory, each of which is input regularly to the inventory database 13 through the retailer computer system in order for the system to automatically suggest a purchase quantity of each product supplied to the retailer.

Data storage module 14 is used to save relevant data from order database 11, purchasing suggestion database 12, and inventory database 13 for the system to automatically create a suggested purchase quantity for each product for each retailer, which is then saved into the purchasing suggestion database 12.

Data input module 15 allows the inventory management staff to set parameters, such as purchasing time periods and safety margins for the system to automatically create a suggested purchase quantity for each product for each retailer as well as allowing the inventory management staff to manually input the suggested quantity of each purchasing product for each retailer.

Calculating module 16 is used to read the past 3 months transaction history of the retailer including the quantity of each ordered product in the order database 11, purchase time period, and safety margin from the purchase suggesting database 12, and the quantity of inventory in stock (that is the total number of the inventory in all warehouses, if more than one warehouse), and using the following formula to calculate a suggested quantity for each product for the retailers. Quantity of suggested purchase=total quantity of purchase in a predetermined period/predetermine time period*purchasing time period*safety margin−quantity of the inventory. In general the predetermined time period is 3 months. For example, the quantity of suggested purchase for a product for a retailer can be obtained by adding up the total quantity of purchase by the retailer over the past 3 months, divided by the number of days in those 3 months, multiplied by the purchasing time period and safety margin, and followed by deducting the total quantity of existing inventory as indicated in the inventory database 13.

Data transfer module 17 is used to transfer purchase suggestion lists (automatically obtained through calculating module 16 or manually input by inventory management staff through data input module 15) to each retailer computer system for the retailers to either approve or modify and transfer the modified or approved purchase suggesting list back to the supplier enterprise resource planning (ERP) system until both sides have come to an agreement on the quantity of the purchase.

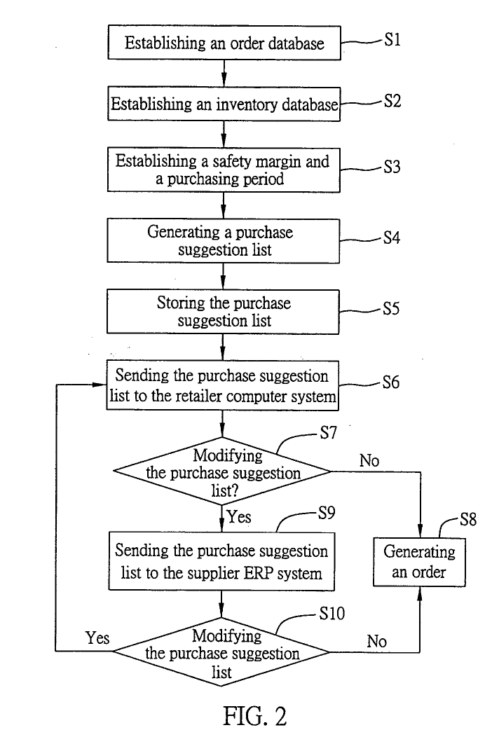

FIG. 2 is a schematic flow chart showing the procedural steps of a method of creating a purchasing suggestion list of the invention. As shown in the drawing, in step S1, the details of the past orders from each retailer, such as order number, retailer number, catalog number, quantity and unit of the purchase, warehouse number, and so on, are regularly input into the order database via the supplier's ERP system 18 in order for the system to collect data to allow it to automatically suggest a purchasing quantity for each product supplied to each retailer.

In step S2, inventory information, such as warehouse number, catalog number, and quantity of inventory in stock, is regularly input into the inventory database 13 via the retailer computer system 19a for the purchase suggesting system 10 to create a suggested quantity of each product for the retailers.

In step S3, data input module 15 is used to set parameters, such as a safety margin and purchasing time period for each product supplied to a retailer, and, using the data storage module 14, save the values of these parameters into the purchase suggestion database 12 to allow the purchase suggestion system 10 to automatically create a suggested quantity for each product for the retailers.

Then, in step S4, data storage module 14 reads the past transactions for the orders of each retailer stored in the order database 11 including the quantity of each product being purchased over the past 3 months, purchasing time period, and a safety margin stored in the purchasing suggestion database 12, and also reads the quantity of the inventory in stock stored in the inventory database 13 (total number of the inventory in all warehouses for each retailer) and, using the following formula, calculates a suggested quantity for each product-for the retailers: quantity suggested for purchase=total quantity of purchase in a predetermined period/predetermined time period*purchasing time period*safety margin−quantity of the inventory. In general the predetermined time period is 3 months. For example, the quantity of a product suggested for purchase for a retailer can be obtained by adding up the total quantity of purchase by the retailer over the past 3 months, divided by the number of days in the 3 months and multiplied by the desired purchasing time period and a safety margin, and then subtracting the quantity of each inventory in the inventory database to obtain the final suggested amount.

This suggested quantity for each product for the retailer then gives rise to a purchase suggestion list which can be also manually input by the inventory management staff.

In step S6, the data storage module 14 reads the information in the purchase suggestion list for each retailer, including retailer number, catalog number, suggesting and quantity of each product, stored in the purchase suggesting database 12, and then transfer the suggestion list to the retailer computer system 19a according to the retailer number, for each retailer to approve or modify the purchase suggestion list.

Next, in step S7, each retailer decides whether they want to make modifications to the purchase suggestion list, and, if the retailer approves the purchase suggestion list without making any modification, the method proceeds directly to step S8, but, if the retailer wishes to modify the details of the purchase suggestion list, a staff member from the retailer then re-enters the catalog number or/and quantity of the product they want to order using the data input module, before the method proceeds to step S9.

In the step S8, approval by the retailer already secured, the purchase suggestion list is input into the order database 11 of the supplier according to the supplier number written on the purchase suggestion list, and an automatic order is then generated.

In step S9, data storage module 14 reads the modified information of the purchase suggestion list, including supplier number, catalog number and the suggested quantity of purchase, and the data transfer module 17 then transfers the purchase suggestion list modified by the retailer to the supplier's ERP system 18 according to the supplier number for the supplier to further make modifications and approve the information on the purchase suggestion list.

Finally, in step S10, if the supplier approves the purchase suggestion list without making any modification, then the process goes to step S8. On the contrary, if the supplier wishes to modify the details of the purchase suggestion list, a staff member from the supplier then re-enters the catalog number or/and quantity of the products that they are prepared to sell using the data input module 15, and then the modified purchase suggestion list is then saved in the purchase suggestion database 12 using the data storage module 14, followed by the method returning to step S6 where the purchase suggesting list is transferred once again to the retailer computer system.

In summary, the method and system of creating a purchase suggestion list comprises: a supplier enterprise resource planning (ERP) system that regularly inputs data of past orders from each of its retail customers into the order database, a retailer computer system regularly that inputs the quantity of each inventory into the inventory database, a data input module for manually inputting the safety margin and purchasing time period, a data storage module to read the order and inventory information, a calculating module for calculating the suggested quantity of each product for purchase, which is also manually adjustable by the inventory management staff, to create a purchase suggesting list, and a data transfer module that transfers this purchase suggestion list to the retailer to make final modifications or grant approval so that a final order can be made under the mutual agreement based on the suggestion purchase list.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A system for creating a purchase suggestion list, established through a connection between a supplier's enterprise resource planning (ERP) system and one or more retailers' computer systems via a network system, the system comprising:
an order database, for storing order related data including at least names and quantity of products to be ordered;
a purchase suggestion database, for storing purchase suggestion data including at least a safety margin and a purchasing time period;
a data input module, for inputting the safety margin and the purchasing time period into the purchase suggestion database;
an inventory database, for storing inventory related data including at least names and quantity of products to be ordered;
a calculating module for reading order related data stored in the order database including the names and quantity of the product to be ordered from the order database, the value of the safety margin and the purchasing time period from the purchase suggestion database, and the quantity of inventory from the inventory database, in order to calculate a suggested purchase quantity of each product for each retailer; and
a data transfer module, for transferring the suggested quantity of each product to the corresponding retailer computer system.

2. (canceled)

3. The system of claim 1, wherein the order database is composed of order data proposed by each retailer, input through the supplier enterprise resource planning (ERP) system into the order database.

4. The system of claim 1, wherein the inventory database is composed of the quantity of each inventory in each warehouse for each retailer, input through the retailer computer system.

5. The system of claim 1, wherein the suggested quantity of each product is obtained by adding up all the purchase quantity within the predetermined time period, then dividing the sum of the purchase quantity by the number of days in the predetermined time period, and then multiplying by the purchase time period and the safety margin, followed by subtracting the quantity of each inventory in the inventory database, thereby obtaining a final suggested quantity for each product.

6. The system of claim 1, wherein the suggested quantity of each product can be stored in the purchase suggestion database.

7. The system of claim 1, wherein the retailer computer system can make modifications to the suggested quantity of each product for purchase.

8. The system of claim 1, wherein the retailer computer system can approve the suggested quantity of each product for purchase and create a final order.

9. The system of claim 1, wherein the data transfer module farther comprises transferring modified suggested quantity of each product for purchase back to the supplier's enterprise resource planning (ERP) system.

10. The system of claim 9, wherein the supplier enterprise resource planning (ERP) system can make further modifications to the suggested quantity of each product for purchase already modified by the retailers computer system.

11. The purchase suggestion system of claim 9, wherein the supplier enterprise resource retailer's computer system can approve the suggested quantity of each product for purchase modified by the retailer's computer system and create a final order.

12. A method of creating the purchase suggestion list, established through a connection between a supplier's enterprise resource planning (ERP) system and one or more retailers' computer systems via a network system, comprising the steps of:
storing order related data including at least the name and quantity of the product to be ordered into an order database;
storing inventory related data including at least the name and quantity of the product to be ordered into an inventory database;
storing purchase suggestion data including at least values of a safety margin and a purchasing time period into a purchase suggestion database;
reading order related data, including the name and quantity of the product to be ordered from the order database, the value of the safety margin and the purchasing time period from the purchase suggestion database, and the quantity of inventory from the inventory database, in order to calculate a suggested quantity of each product for purchase for each retailer;
storing the suggested quantity of each product in the purchase suggestion database; and
transferring the suggested quantity of each product to the corresponding retailer's computer system.

13. The method of claim 12, wherein the order related data is input through the supplier's enterprise resource planning (ERP) system.

14. The method of claim 12, wherein the inventory related data is input through the retailer's computer system.

15. The method of claim 12, wherein the suggested quantity of each product is obtained by adding up all purchase quantity within a predetermined time period, then dividing the sum of purchase quantity by the number of days in the predetermined time period, then multiplying by the purchase time period and the safety margin, and then subtracting the quantity of each inventory in the inventory database, thereby obtaining a final suggested quantity for each product.

16. (canceled)

17. The method of claim 12, further comprising making modifications to the suggested quantity of each product for purchase through the retailer's computer system.

18. The method of claim 12, further comprising an approval cycle for the suggested quantity of each product for purchase to create a final order through the retailer's computer system.

19. The method of claim 12, further comprising the transfer of the modified suggested quantity of each product of purchase back to the supplier's enterprise resource planning (ERP) system.

20. The method of claim 12, further comprising making further modifications to the suggested quantity of each product for purchase modified by the retailer computer system through the supplier's enterprise planning (ERP) system.

21. The method of claim 12, further comprising an approval of the suggested quantity of each product of purchase to create a final order through the retailer's computer system.

22. A system for creating a purchase suggestion list, established through a connection between a supplier's enterprise resource planning (ERP) system and one or more retailers' computer systems via a network system, the system comprising:
an order database, for storing order related data including at least names and quantity of products to be ordered;
a purchase suggestion database, for storing purchase suggestion data including at least a safety margin and a purchasing time period;
an inventory database, for storing inventory related data including at least names and quantity of products to be ordered;
a calculating module for reading order related data stored in the order database including the names and quantity of the product to be ordered from the order database, the value of the safety margin and the purchasing time period from the purchase suggestion database, and the quantity of inventory from the inventory database, in order to calculate a suggested purchase quantity of each product for each retailer; and
a data transfer module, for transferring the suggested quantity of each product to the corresponding retailer computer system and storing the suggested quantity of each product in the purchase suggestion database.

23. The system of claim 22, further comprising a data input module for inputting the safety margin and the purchasing time period into the purchase suggestion database.

24. The system of claim 22, wherein the order database is composed of order data proposed by each retailer, input through the supplier enterprise resource planning (ERP) system into the order database.

25. The system of claim 22, wherein the inventory database is composed of the quantity of each inventory in each warehouse for each retailer, input through the retailer computer system.

26. The system of claim 22, wherein the suggested quantity of each product is obtained by adding up all the purchase quantity within the predetermined time period, then dividing the sum of the purchase quantity by the number of days in the predetermined time period, and then multiplying by the purchase time period and the safety margin, followed by subtracting the quantity of each inventory in the inventory database, thereby obtaining a final suggested quantity for each product.

27. The system of claim 22, wherein the retailer computer system can make modifications to the suggested quantity of each product for purchase.

28. The system of claim 22, wherein the retailer computer system can approve the suggested quantity of each product for purchase and create a final order.

29. The system of claim 22, wherein the data transfer module further comprises transferring modified suggested quantity of each product for purchase back to the supplier's enterprise resource planning (ERP) system.

30. The system of claim 29, wherein the supplier enterprise resource planning (ERP) system can make further modifications to the suggested quantity of each product for purchase already modified by the retailer's computer system.

31. The purchase suggestion system of claim 29, wherein the supplier enterprise resource retailer's computer system can approve the suggested quantity of each product for purchase modified by the retailer's computer system and create a final order.
